(19) United States
(12) Patent Application Publication
(10) Pub. No.: US 2010/0038604 A1
(43) Pub. Date: Feb. 18, 2010

(54) Nickel Paste

(75) Inventor: Tsutomu SUGIYAMA, Nagoya-shi (JP)

Correspondence Address: OLIFF & BERRIDGE, PLC, P.O. BOX 320850, ALEXANDRIA, VA, 22320-4850, US

(73) Assignee: NORITAKE CO., LIMITED, NAGOYA (JP)

(21) Appl. No.: 12/546,495

(22) Filed: Aug. 24, 2009

Related U.S. Application Data
(63) Continuation-in-part of application No. 12/219,828, filed on Jul. 29, 2008, now abandoned.

(30) Foreign Application Priority Data
Aug. 3, 2007 (JP) 2007-203296

(51) Int. Cl. H01B 1/22

(52) U.S. Cl. 252/513

(57) ABSTRACT

Nickel paste contains nickel powder, a resin binder and an organic solvent, wherein the nickel powder is a small amount sulfur nickel powder including less than 100 ppm sulfur. This provides the nickel paste that the change in viscosity due to sulfur included in the paste can be preferably restrained by using nickel powder including extremely small amount of sulfur. Limitation of sulfur to the extremely small amount causes superior stability, and then, since kinds of solvents and resin binders are not limited, the change in viscosity can be preferably restrained with using the solvent that is hard to cause the chemical attack on the green sheet as described above. Thus, nickel paste that is hard to cause the chemical attack and the change in viscosity can be provided.

This application is a continuation-in-part application of patent application Ser. No. 12/219,828.

### BACKGROUND OF THE INVENTION

1. Field of the Invention

The present invention relates to nickel paste that is preferable for forming such as an internal electrode in a multi-layer ceramic capacitor (MLCC).

2. Description of Related Art

FIG. 1 diagrammatically illustrates an MLCC 10 in a cross-sectional view. The MLCC 10 includes a dielectric layer 12, a conductive layer 14 (hereinafter, “conductive” means “electrically conductive”,) functioning as an internal electrode, and an external electrode 16 for applying an electric current to the conductive layer 14. The MLCC 10 is manufactured by laying conductive paste including thermal resistant metal as a conductive component on the surface of an unburnt ceramic green sheet in such as a thick-film screen printing method to form a conductive paste layer, repeating to form the conductive paste layer several times to form a multilayer including the green sheets and the conductive paste layers, pressing the multilayer to bond the green sheets and the conductive paste layers each other, and burning the multilayer to form the dielectric layer 12 generated from the green sheet and the conductive layer 14 generated from the conductive paste layer.

The ceramic green sheet described above is manufactured by forming from a slurry including, in general, such as ceramic powder, a binder and a solvent in such as a doctor blade process. Organic compound such as butyral resin and acrylic resin, for instance, is used as the binder. Organic solvent such as toluene, for instance, is used as the solvent.

The above conductive paste contains such as conductive powder, the binder and the solvent. Metal material having proper thermal resistance against the burning temperature for the dielectric layer 12, for instance, Pt, Pd, Ag—Pd, Ag, Ni or Cu are used as the conductive powder. Low-cost base metal materials, especially, nickel alloys became rapidly used in recent days in response to requiring further lower costs for electronic materials. Organic compound capable of being burnt out with facility and leaving a little ash, for instance, alkyd resin or ethylcellulose is used as the binder. Organic compound that gives proper viscosity to the paste and capable of being volatilized with facility in the drying treatment after layered on the green sheet, for instance, terpineol, butyl Carbitol™ acetate or kerosine is, in general, used as the solvent. Such as dihydro terpineol acetate or dihydro terpineol is used for the conductive paste due to its stability in viscosity with no changes with time.

Down-sized and thinned MLCCs maintaining preferable capacitance are expected for achieving such as down-sizing and high performance of such as portable electronic devices. Many MLCCs has external dimensions of 1.0 mm and 0.5 mm that is called “1005”, and has a thickness of 0.5 mm. Further capacitance is required for larger MLCCs within the same dimensions as before. Thus, MLCCs are expected to have thinner possible dielectric layers 12 in order to have more layers in any cases. Increasing in its layers requires more conductive powder, and consequently, it causes a burden on manufacturers, then, low-cost nickel alloy conductive powder becomes further needed.

Such as terpineol conventionally used as the solvent for the conductive paste dissolves organic binders such as butyral resin and acrylic resin included in the ceramic green sheet to change such as the thickness and density of the green sheet. It is called “a chemical attack on the green sheet”, and prevents achieving the thinner dielectric layer 12 due to its considerable loss in thickness for a comparative thinner ceramic green sheet. Since the conductive paste is required for affinity to the green sheet, affinity has been conventionally achieved by using the solvent providing solubility. However, thinner dielectric layer 12 suffers from such characteristics.

Instead of such as terpineol and dihydro terpineol, a low-soluble solvent is used for the thinner dielectric layer 12. For instance, a dihydro terpineol derivative series solvent or a mixed solvent of dihydro terpineol and petroleum solvent of such as hydrocarbon is used. For instance, a thinner is used as the petroleum solvent of the latter, and dihydro terpineol and the thinner is mixed at a ratio of, for example, about 7:3.

The conductive paste containing a solvent that is hard to provide the above chemical attack tends to change in its viscosity with time in store. Especially, nickel alloy conductive powder due to its low cost considerably tends to change in its viscosity with time. Nickel is expected to function as a catalyst with no idea for its reason. A change in viscosity of the paste causes various disadvantages in the manufacturing process such as improper thickness and shape of the layer upon printing or generation of cracks after burnt.

There are various conventional ways to restrain the change in viscosity for stability. JP 2006-004905 A, for instance, discloses cupper paste with phosphate ester compound functioning as a dispersant to restrain the change in viscosity. JP 2006-012690 A, for instance, discloses nickel paste including butyral resin as a binder using a solvent including terpineol acetate as a main component to restrain the change in viscosity. JP 2005-243333 A, for instance, discloses polyacrylate copolymer as a resin binder to restrain the change in viscosity. JP2001-006436 A, for instance, discloses nickel paste and cupper paste including a binder such as ethylcellulose and a solvent such as terpineol, with amine series surface active agent functioning as a dispersant to restrain the change in viscosity.

The above JP 2006-004905 A, JP 2006-012690 A, JP 2005-243333 A and JP 2001-006436 A disclose technique by stabilizing the surface and restrain the catalyst effect by adding organic dispersant and adsorbing it to the surface of the conductive powder, or by using a specified solvent and a specified resin binder, to restrain the change in viscosity. Nickel paste adopting these techniques is expected to concurrently solve the problems of the above chemical attack and the change in viscosity. However, the composition of nickel paste should be appropriately arranged in accordance with use and required characteristics. Accordingly, the above techniques cannot be universal because it is necessary to select a proper organic dispersant and determine the amount of addition in accordance with the solvent and the resin binder, or optimization of the solvent and the resin binder is needed. Although addition of sufficiently large amount of the organic dispersant causes stability in viscosity with facility for various kinds of the solvents and the resin binders, excessive addition of the organic dispersant sometimes causes disadvantageous effects for the paste characteristics such as low density of the dried layer, low degreasing, a remarkable change in viscosity characteristics (rheology).

It is therefore an object of the present invention to provide nickel paste that is hard to cause the chemical attack and the change in viscosity.

### SUMMARY OF THE INVENTION

The object indicated above may be achieved according to a first aspect of the invention, which provides nickel paste containing nickel powder, a resin binder and an organic solvent, wherein the nickel powder is small amount sulfur nickel powder (nickel powder including small amount of sulfur) manufactured by a small amount sulfur manufacturing process and includes less than 100 ppm sulfur.

This provides the nickel paste that the change in viscosity due to sulfur included in the paste can be preferably restrained by using nickel powder which is the small amount sulfur nickel powder which is manufactured by the small amount sulfur manufacturing process and which includes less than 100 ppm sulfur. Limitation of sulfur to the extremely small amount causes superior stability, and then, since kinds of solvents and resin binders are not limited, the change in viscosity can be preferably restrained with using the solvent that is hard to cause the chemical attack on the green sheet as described above. Thus, nickel paste that is hard to cause the chemical attack and the change in viscosity can be provided.

JP 11-080816 A, JP 3787032 B and JP 2006-099965 A disclose the conventional nickel powder or nickel paste having, for instance, 500 ppm sulfur or more for high dispersibility of the nickel powder in the paste or improvement in removability by burning and flammability of resin at the low temperature. When nickel powder was used, it was believed preferable that sulfur was included at least in the paste, and the nickel paste including no sulfur has not been imagined to prepare. However, the inventor of the present invention studied to improve stability of the nickel paste and has found that stability of the nickel paste is considerably improved by using the nickel powder which is the small amount sulfur nickel powder manufactured by the small amount sulfur manufacturing process and includes less than 100 ppm sulfur (hereinafter, briefly referred to as “small amount sulfur nickel powder” properly), in comparison to use of the conventional nickel powder including sulfur. The present invention is made based upon these affairs.

It is believed that sulfur causes forming of crosslinks by affecting molecules of the resin binder in the paste, to tend to change in viscosity due to a large amount of sulfur included. Although sulfur included in nickel powder, that is, sulfur chemically bonded to nickel is hard to cause the change in viscosity in comparison to that freely included in the paste, in both cases sulfur in the paste causes reduction in stability in viscosity. Consequently, it is requisite not only to add no sulfur into the paste but also to use small amount sulfur nickel powder which includes extremely small amount of sulfur, for stability in viscosity.

The object indicated above may be achieved according to a third aspect of the invention, which provides the paste of the first aspect of the invention, wherein the small amount sulfur nickel powder includes substantially no sulfur. This provides further stability in viscosity. It should be noted that “no sulfur” in this patent application means that there is no sulfur that can be detected by both of the infrared absorption method and the inductively coupled plasma spectrometry generally used for analysis of impurities in small amount sulfur nickel powder.

The object indicated above may be achieved according to a second aspect of the invention, which provides the paste of the first aspect of the invention, wherein the organic solvent is a dihydro terpineol derivative (such as dihydro terpineol propionate) or a petroleum solvent. This provides the nickel paste that is superior in stability in viscosity and is further hard to cause chemical attacks because the pastes using a dihydro terpineol derivative or a petroleum solvent are hard to cause chemical attacks. Any organic solvent may be used as the nickel paste according to the present invention. Such as conventional terpineol, terpineol derivatives such as dihydro terpineol, or a mixture of the above solvents and a petroleum solvent may be preferably used. For a considerably thin sheet to be applied with the paste having 3 μm in thickness or less, further preferably, 1 μm or less, because the effect of the chemical attacks are seriously nonnegligible, it is preferable to use a dihydro terpineol derivative or a petroleum solvent.

The object indicated above may be achieved according to a fourth aspect of the invention, which provides the paste of the first aspect of the invention, wherein the resin binder is ethylcellulose. Various kinds of resin binders may be used, and, for instance, polyvinyl butyral, acrylic series resin or epoxy resin may be appropriately used. Ethylcellulose may be preferably used when dihydro terpineol derivatives is used as the organic solvent.

The object indicated above may be achieved according to a fifth aspect of the invention, which provides the paste of the first aspect of the invention, further comprising a dispersant. The conventional appropriate dispersant may be used, and, for instance, vinyl polymer, polycarboxylic amine salt or polycarboxylic compounds may be used.

The conductive paste according to the present invention may contain other organic solvent or solvents in addition to a dihydro terpineol derivative as an organic solvent. Such as butyl Carbitol™, butyl Carbitol™ acetate, higher alcohols or petroleum solvents may be used as the organic solvent.

The nickel paste according to the present invention may contain the appropriate amount of a component of unburnt ceramic that will be applied with, such as fine powder of ceramic to constitute the green sheet or glass powder, in addition to the small amount sulfur nickel powder, resin binder and organic solvent. The addition may be concurrently added into the nickel paste when the small amount sulfur nickel powder is mixed with the resin binder and organic solvent. This causes higher strength in bonding between the sheet and conductive layer and the difference therebetween in thermal expansion coefficients will be moderated. In this case, the average grain diameter of the added ceramic fine powder preferably ranges from 0.02-0.3 μm, further preferably, from 0.03-0.1 μm.

The nickel paste according to the present invention may be used for forming the conductive layer for various uses, preferably, for forming ceramic electronic components, especially, multi-layer (or laminated) ceramic electronic components such as internal conductive components in the MLCCs. The conductive paste according to the present invention may be especially preferably used for an extremely thin ceramic layer such as a dielectric layer.

The nickel paste according to the present invention may be especially preferably used for forming the conductive layer on the unburnt ceramic including the binder to be dissolved by such as terpineol or dihydro terpineol acetate, and preferably used for the green sheet including the organic binder such as polyvinyl butyral resin or acrylic resin.

### BRIEF DESCRIPTION OF THE DRAWINGS

FIG. 1 diagrammatically illustrates a multi-layer ceramic capacitor (MLCC) in a cross-sectional view.

FIG. 2 is a graph showing the increase in viscosity for Comparatives 3 and 4 and Embodiment 3.

FIG. 3 is a graph showing the increase in viscosity for Comparative 5 and Embodiment 4.

FIG. 4 is a graph showing the increase in viscosity for Comparative 6 and Embodiment 5 in the accelerated test.

FIG. 5 is a graph showing the increase in viscosity for Embodiments 6-8 and Comparatives 7 and 8 having different amounts of sulfur in the pastes each other.

FIG. 6 is a graph showing the increase in viscosity for Comparatives 9-12 having different dispersants added, in comparison to Comparative 2 and Embodiment 2.

### DETAILED DESCRIPTION OF EXEMPLARY EMBODIMENTS

Hereinafter, there will be described the present invention by reference to the drawings. The figures are appropriately simplified or transformed, and all the proportion of the dimension and the shape of a portion or member may not be reflective of the real one in the following embodiments.

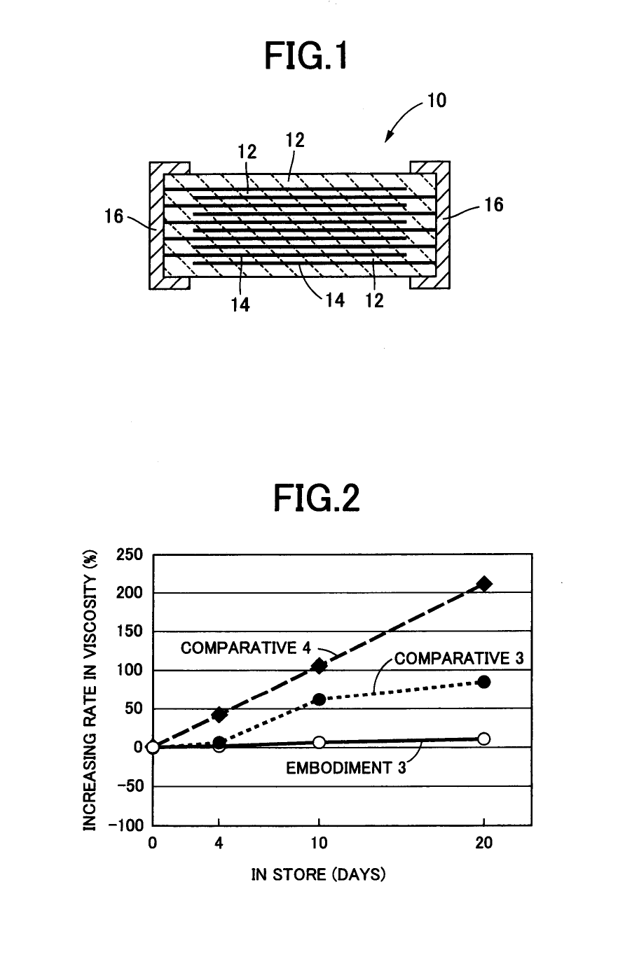

The Tables 1-3 show the results of tests for nickel paste of Embodiments 1-3 according to the present invention and Comparatives 1-3 with respect to components and stability. This nickel paste is, for instance, used for forming the conductive layer 14 in the manufacturing process of the MLCC 10 shown in FIG. 1. The dielectric layer 12 of the MLCC 10 is made of such as barium titanate, and the thickness before burnt is, for instance, about 3 μm.

TABLE 1

| | Comparative 1 | Embodiment 1 |
|---|---|---|
| Nickel Powder | Sample 1 (Including Sulfur) | Sample 2 (Including |
| | | No Sulfur) |
| Ceramic | Barium Titanate | |
| Resin | Ethylcellulose | |
| Solvent | Dihydro Terpineol | |
| Dispersant | Vinyl Polymer | |
| Others | Rosin | |
| Change in Viscosity | +60% | +30% |
| (At 50° C. | | |
| for a Month) | | |

TABLE 2

| | Comparative 2 | Embodiment 2 |
|---|---|---|
| Nickel Powder | Sample 3 (Including Sulfur) | Sample 4 (Including |
| | | No Sulfur) |
| Ceramic | Barium Titanate | |
| Resin | Ethylcellulose | |
| Solvent | n-Alcohol and n-Paraffin | |
| Dispersant | Vinyl Polymer and Polycarboxylic Amine Salt | |
| Change in Viscosity | +200% | +40% |
| (At 50° C. | | |
| for a Week) | | |

TABLE 3

| | Comparative 3 | Embodiment 3 |
|---|---|---|
| Nickel Powder | Sample 3 (Including Sulfur) | Sample 4 (Including |
| | | No Sulfur) |
| Ceramic | Barium Titanate | |
| Resin | Ethylcellulose | |
| Solvent | Dihydro Terpineol Propionate | |
| Dispersant | Polycarboxylic Compound | |
| Change in Viscosity | +95% | +10% |
| (At 25° C. | | |
| for a Month) | | |

In the line of Nickel Powder in Tables 1-3, there are shown kinds of the small amount sulfur nickel powder manufactured by the small amount sulfur manufacturing process and includes less than 100 ppm sulfur (hereinafter, briefly referred to as “small amount sulfur nickel powder” properly) used in respective Embodiments, and the nickel powders used in respective Comparatives. Sample 1 contains nickel powders having about 0.4 μm in grain diameter on average and about 1.7 m²/g in specific surface area, and includes about 800 ppm sulfur in weight. Sample 2 contains small amount sulfur nickel powders having about 0.4 μm in grain diameter on average and about 1.8 m²/g in specific surface area, and includes substantially no sulfur. Although Sample 1 of nickel powder is manufactured by a conventional or available manufacturing process, while Sample 2 of small amount sulfur nickel powder is manufactured by the small amount sulfur manufacturing process and includes less than 100 ppm sulfur, they have almost the same characteristics other than the presence of sulfur.

One manufacturing process of the Sample 2 of small amount sulfur nickel powder by the small amount sulfur manufacturing process will be exemplarily explained. For example, nickel chloride solution is electrolyzed to provide small amount sulfur metal nickel including less than 100 ppm sulfur. The metal nickel including small amount sulfur is heated and is chlorinated by chlorine gas to create nickel chloride vapor which is then condensed and collected to provide the nickel chloride. Nickel chloride thus obtained is changed to nickel power including less than 100 ppm sulfur by a so-called chemical vapor deposit (CVD), in which nickel chloride is sublimated with using inert gas such as nitrogen gas or argon gas as carrier gas, and is reduced by hydrogen to provide the small amount sulfur nickel powder.

Sample 3 contains nickel powders having about 0.2 μm in grain diameter on average and about 3.2 m²/g in specific surface area, and includes about 1200 ppm sulfur in weight. Sample 4 contains small amount sulfur nickel powders having about 0.2 μm in grain diameter on average and about 3.1 m²/g in specific surface area, and includes substantially no sulfur. Although Sample 3 of nickel powder is manufactured by the conventional or available manufacturing process which is the same for the above Sample 1, while Sample 4 of small amount sulfur nickel powder is manufactured by the small amount sulfur manufacturing process which is the same for the above Sample 3 and includes less than 100 ppm, they have almost the same characteristics other than the presence of sulfur. The amount of the nickel powder or small amount sulfur nickel powder ranges from, for instance, 40-60 wt % (or % in weight) of the total of the paste and is, for example, 50 wt %.

In the line of Ceramic, there is shown the kind of ceramic powder added so that the contraction curves of the nickel paste and of the dielectric layer 12 upon burnt in the burning step overlap each other, that is, so that the nickel paste and the dielectric layer 12 have the substantially equal contraction coefficients with time. Since the dielectric layer 12 is made of barium titanate in this embodiment, for instance, barium titanate having about 0.02-0.3 μm in grain diameter on average was used. The added amount of the ceramic powder is, for instance, 20 wt % or less of the total of the paste and is, for example, 10 wt %.

In the lines of Resin and Solvent, there are shown the kinds of components as vehicles for dispersing small amount sulfur nickel powder. Ethylcellulose is used for Resin, and for Solvent, dihydro terpineol is used in Comparative 1 and Embodiment 1, a mixture of n-alcohol and n-paraffin is used in Comparative 2 and Embodiment 2, and dihydro terpineol propionate is used in Comparative 3 and Embodiment 3, respectively. Ethylcellulose is, for instance, about 3-10 wt % and the balance is the solvent, that is, the solvent is about 97-90 wt % of the vehicle. Rosin was added into Comparative 1 and Embodiment 1 with dihydro terpineol in order to provide the dried layer with adhesive properties. The added amount of the vehicle ranges from, for instance, 32-56 wt % and is, for example, 39 wt % of the total of the paste, and the amount of ethylcellulose ranges from, for instance, 2-6 wt % and is, for example, 3 wt %, and the amount of the solvent ranges from, for instance, 30-50 wt % and is, for example, 36 wt %. The vehicle is prepared by adding the solvent to the resin and by heating to be dissolved, for instance, at 110° C. for about 16-24 hours.

In the line of Dispersant, there are shown the kinds of the dispersant to promote dispersion of small amount sulfur nickel powder in the paste. Vinyl polymer was used in Comparative 1 and Embodiment 1, a mixture of vinyl polymer and polycarboxylic amine salt was used in Comparative 2 and Embodiment 2, and polycarboxylic compound was used in Comparative 3 and Embodiment 3, respectively. The same vinyl polymer was used in Comparative 1 and Embodiment 1, and Comparative 2 and Embodiment 2. The added amount of the dispersant is, for instance, 2 wt % or less of the total paste and is, for example, about 1 wt %.

Each paste in Comparatives and Embodiments are prepared by mixing the nickel powder or small amount sulfur nickel powder, ceramic powder, vehicle and dispersant, and by sufficiently dispersing the nickel powder or small amount sulfur nickel powder and ceramic powder by the triple roll mill. Filtering after kneading is performed if necessary.

The MLCC 10 in FIG. 1 is manufactured by applying the above nickel paste on the green sheet including such as polyvinyl butyral resin as a binder that is manufactured in another process, in a predetermined pattern such as in the thick-film screen printing process, by pressing the laminated green sheets with the applied nickel paste layers therebetween in the thickness direction to be contactually bonded, and by burning it in a predetermined mood and at a predetermined temperature.

In the line of Change in Viscosity in Tables 1-3, there are shown the increasing rate in viscosity after long-term storing in a condition defined between parentheses. The increasing rate in viscosity is determined by measuring the viscosity of the respective pastes just after prepared, by measuring the viscosity of the pastes after stored, the samples in Table 1 at 50° C. for a month, the pastes in Table 2 at 50° C. for a week, and the pastes in Table 3 at 25° C., that is, at the room (or usual) temperature for a month, and by calculating the percentage of the increasing rate in viscosity in such a way that the increased viscosity is divided by the viscosity just after prepared. Tables 1 and 2 show the results of accelerated tests based upon the knowledge of two- to five-times acceleration in viscosity change for the paste stored at 50° C., with respect to the paste stored at 25° C.

While Comparative 1 having nickel powder of Sample 1 including 800 ppm sulfur resulted in 60% increasing in viscosity, Embodiment 1 having small amount sulfur nickel powder of Sample 2 including no sulfur resulted in up to 30% increasing in viscosity in Table 1. For stability the paste requires 20% or less, preferably, 15% or less, increasing in viscosity in storing at 25° C. for a month. The paste of Comparative 1 meets the requirement, that is, has 20% or less increasing in viscosity, under that condition.

While Comparative 2 having nickel powder of Sample 3 including 1200 ppm sulfur resulted in 200% increasing in viscosity, Embodiment 2 having small amount sulfur nickel powder of Sample 4 including no sulfur resulted in up to 40% increasing in viscosity in Table 2. The paste using the petroleum solvent in Table 2 has an advantage that it is hard to cause the chemical attack on the green sheet and a disadvantage that it tends to result in the change in viscosity. It is found that while the paste including sulfur results in the considerable change in viscosity and is not expected to be practical even in consideration for the result of the accelerated test, the paste including no sulfur results in the comparatively small change in viscosity even using the petroleum solvent, with sufficient stability.

The dihydro terpineol derivative such as dihydro terpineol propionate in Table 3 is a solvent that is hard to cause the chemical attack on the green sheet in comparison to dihydro terpineol. While using this solvent Comparative 3 having nickel powder of Sample 3 including 1200 ppm sulfur resulted in 95% increasing in viscosity after stored at 25° C. for a month, Embodiment 3 having small amount sulfur nickel powder of Sample 4 including no sulfur resulted in up to 10% increasing in viscosity, with superior stability. FIG. 2 illustrates the results of increasing in viscosity for the above Comparative 3 and Embodiment 3 for the first twenty days. While the viscosity of the nickel paste of Comparative 3 substantially remains at the original level for about the first four days, and then rapidly increases, the viscosity of the nickel paste of Embodiment 3 shows substantially no increase, that is, substantially remains at the original level.

Comparative 4 in FIG. 2 has the nickel paste of Embodiment 3 with 1000 ppm sulfur added, to examine effects by the presence of sulfur. FIG. 2 apparently shows that Comparative 4 having sulfur added in the paste has no stability in viscosity. Furthermore, it also shows the remarkable increase than Comparative 3 having sulfur in the nickel powder does.

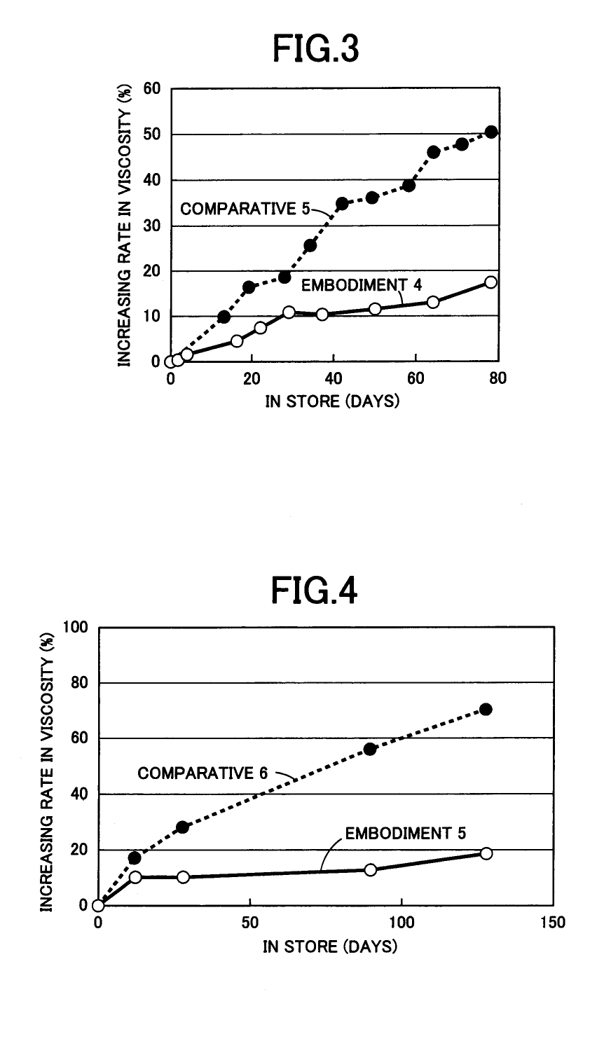

FIG. 3 shows the results of the increasing rate in viscosity for the pastes using the solvent that dihydro terpineol and the thinner is mixed at the rate of about 7:3. Comparative 5 contains nickel powder of Sample 3, Embodiment 4 contains small amount sulfur nickel powder of Sample 4, and both contain the dispersant having vinyl polymer and polycarboxylic amine salt. They have the components in the same rate as in the respective Comparatives and Embodiments. The above solvent can mitigate the chemical attack by adding the thinner, the petroleum (hydrocarbon) solvent. The paste of Comparative 5 having nickel powder including sulfur shows the remarkable increase in viscosity in a short period in comparison to the paste of Embodiment 4 having small amount sulfur nickel powder including no sulfur. This Comparative 5 somehow meets requirement in characteristics at present, showing the increase of less than 20% in viscosity after stored at 25° C. for thirty days. Use of small amount sulfur nickel powder including no sulfur is, accordingly, advantageous when such a solvent is used.

FIG. 4 shows the results of the increasing rate in viscosity in the accelerated test for another pastes using dihydro terpineol as the solvent. This test was conducted under the same conditions as that for Comparative 5 and Embodiment 4 shown in FIG. 3, other than use of the different solvent. Sample 3 nickel powder was used for Comparative 6 and Sample 4 small amount sulfur nickel powder was used for Embodiment 5, respectively. It was found that Comparative 6 including sulfur showed the remarkable increase in viscosity in comparison to Embodiment 5 including no sulfur.

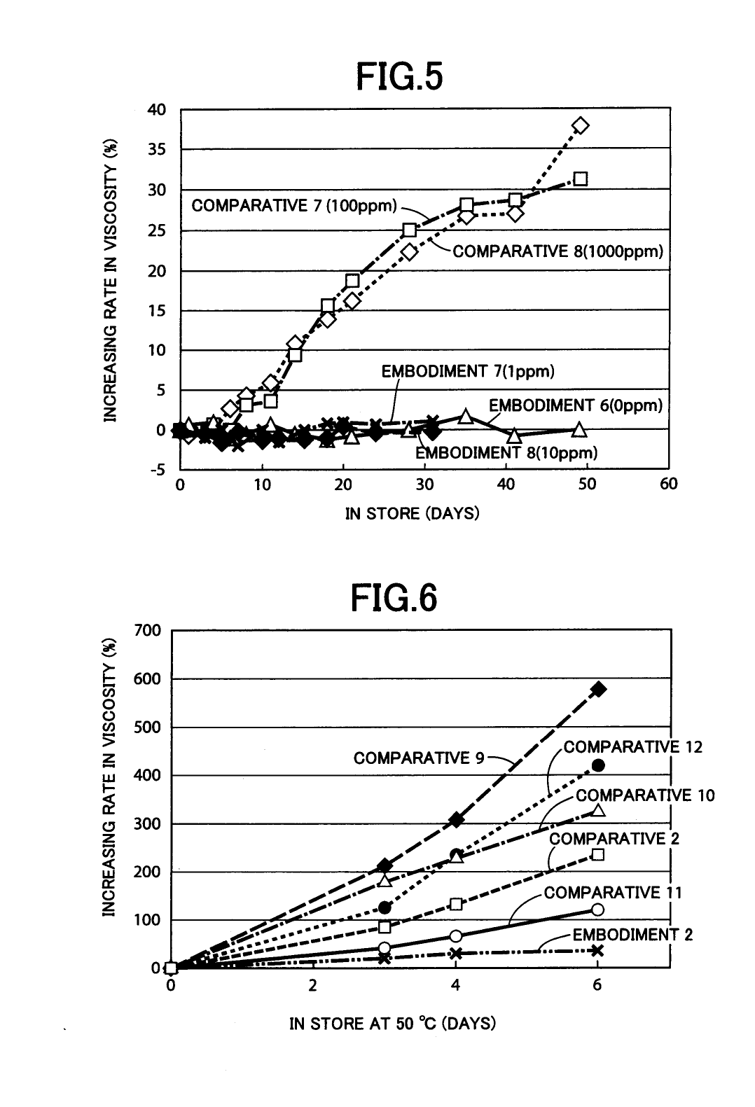

FIG. 5 shows the results of the increasing rate in viscosity for the pastes having the small amount sulfur nickel powder of Sample 4 including no sulfur and having about 0.2 μm in grain diameter on average, that has the same composition as that of Embodiment 2, other than use of dihydro terpineol as the solvent. It plots Embodiment 6 having no sulfur in the paste, Embodiment 7 having 1 ppm sulfur added with respect to the amount of the nickel powder, Embodiment 8 having 10 ppm sulfur added with respect to the amount of the nickel powder, Comparative 7 having 100 ppm sulfur added with respect to the nickel powder, and Comparative 8 having 1000 ppm sulfur added with respect to the amount of the nickel powder. The test was conducted under the same condition as that in Table 3, that is, they were measured after stored at 25° C.

FIG. 5 shows almost no change in viscosity for Embodiments 6-8 having sulfur added 10 ppm or less even after stored in considerable days. The observations continued for fifty days for Embodiment 6 having no sulfur, and for thirty days for Embodiments 7 and 8. FIG. 5 also shows the remarkable increase in viscosity for Comparatives 7 and 8 having 100 ppm or more sulfur. It is found that although Comparatives 7 and 8 are different in the amount of sulfur added, they are almost equal in the increasing rate in viscosity. The results shows that addition of 100 ppm or more sulfur causes considerably inferior stability in viscosity, and addition of less than 100 ppm sulfur, preferably, 10 ppm or less sulfur, is required for superior stability in viscosity.

FIG. 6 shows the results of tests with various dispersants to restrain increases in viscosity, using Comparative 2 that resulted in considerable change in viscosity shown in Table 2. It also shows Embodiment 2 and Comparative 2. Comparatives 2 and 9-12 contains different dispersants each other. Details of the dispersants are omitted because it is not necessary for disclosing ineffectiveness by variation in dispersants. It is found in FIG. 6 that variation in dispersants causes variation in effectiveness to some extent, for instance, Comparative 11 restrains the increase in viscosity in comparison to Comparative 2. However, even superior Comparative 11 shows the increase over 100% in viscosity after stored at 50° C. for six days.

Embodiment 2 having no sulfur shows only about 35% increases in viscosity. In conclusion, although it is possible to restrain increases in viscosity by addition of proper dispersants, it cannot provide an effective solution for such a paste showing the considerable increase in viscosity like Comparative 2. It is required to use small amount sulfur nickel powder having no sulfur or less than 100 ppm sulfur.

As described above, the change in viscosity due to sulfur in the nickel paste in Embodiments 1-8 can be preferably restrained by using small amount sulfur nickel powder including no sulfur or less than 100 ppm sulfur. Accordingly, since kinds of solvents and resin binders are not limited, the change in viscosity can be preferably restrained with using the solvent that is hard to cause the chemical attack on the green sheet shown in Embodiments 2 and 3. Thus, nickel paste that is hard to cause the chemical attack and the change in viscosity can be provided.

It is to be understood that the present invention may be embodied with other changes, improvements, and modifications that may occur to a person skilled in the art without departing from the scope and spirit of the invention defined in the appended claims.

What is claimed is:

1. Nickel paste containing nickel powder, a resin binder and an organic solvent, wherein the nickel powder is small amount sulfur nickel powder manufactured by a small amount sulfur manufacturing process and includes less than 100 ppm sulfur.

2. The nickel paste of claim 1, wherein the organic solvent is a dihydro terpineol derivative or a petroleum solvent.

3. The nickel paste of claim 1, wherein inclusion amount of sulfur in the small amount sulfur nickel powder is less than 10 ppm.

4. The nickel paste of claim 3, wherein the small amount sulfur nickel powder includes substantially no sulfur.

5. The nickel paste of claim 1, wherein the resin binder is ethylcellulose.

6. The nickel paste of claim 1, further comprising a dispersant.
